(19) United States
(12) Patent Application Publication
(10) Pub. No.: US 2010/0204864 A1
(43) Pub. Date: Aug. 12, 2010

(54) HYBRID VEHICLE AND CONTROL METHOD THEREOF

(75) Inventors: Ikuo Ando, Toyota-shi (JP); Daigo Ando, Nagoya-shi (JP)

Correspondence Address: GIFFORD, KRASS, SPRINKLE,ANDERSON & CITKOWSKI, P.C, PO BOX 7021, TROY, MI, 48007-7021, US

(73) Assignee: TOYOTA JIDOSHA KABUSHIKI KAISHA, Toyota-Shi (JP)

(21) Appl. No.: 12/700,974

(22) Filed: Feb. 5, 2010

(30) Foreign Application Priority Data
Feb. 5, 2009 (JP) JP2009-25076

(51) Int. Cl. G06F 19/00

(52) U.S. Cl. 701/22; 180/65.265

(57) ABSTRACT

When the catalyst warm-up is not completed and the driving power Pdrv is larger than the battery output allowable power (k·Wout), the power demand Pe* to be output from the engine 22 is set as a power obtained by subtracting the battery output allowable power from the driving power Pdrv (S130) and the engine 22 and the motors MG1 and MG2 are controlled so that the engine 22 outputs the power demand Pe* and the hybrid vehicle 20 is driven with the driving power Pdrv (S160, S190 through S230). This arrangement enables the hybrid vehicle 20 to be driven with output of the driving power Pdrv while preventing more the emission of exhaust from becoming worse, in comparison to the case where the power demand Pe* is set as the driving power Pdrv and the control is performed.

### BACKGROUND OF THE INVENTION

1. Field of the Invention

The present invention relates to a hybrid vehicle and a control method thereof. More specifically, the invention pertains to a hybrid vehicle having an internal combustion engine with an exhaust system that an exhaust purification device including a purifying catalyst for purifying exhaust is attached, a motor, and a battery that supplies and receives electric power to and from the motor, both of the internal combustion engine and the motor being capable of outputting power for driving the hybrid vehicle and the hybrid vehicle having a capability of being driven only with output power from the motor, and a control method of such a hybrid vehicle.

2. Description of the Related Art

In one proposed hybrid vehicle, when a motor is not under abnormal conditions upon start-up of an engine, the engine is operated in an appropriate operation state for catalyst warm-up in order to accelerate warming up of a catalyst of an exhaust purification device attached to an exhaust system of the engine (see, for example, Patent Document 1). In this hybrid vehicle, emission of exhaust is prevented from becoming worse by performing the catalyst warm-up.

### Patent Document 1: Japanese Patent Laid-Open No. 2006-249983

### SUMMARY OF THE INVENTION

In the proposed hybrid vehicle, while operating the engine in the appropriate operation state for the catalyst warm-up, the hybrid vehicle is basically driven with driving power output from the motor using electric power from the battery. When an accelerator pedal is largely stepped on and the electric power from the battery cannot afford the driving power, such control is performed that control of the engine and the motor so that the hybrid vehicle is driven with the driving power output from the engine discontinuing the engine operation in the appropriate operation state for the catalyst warm-up. In this case, the catalyst warm-up is not completed and emission of exhaust becomes worse. Especially in such a cold air case that an outside air temperature is less than or equal to minus 10 degrees centigrade, a maximum allowable electric power to be output from the battery becomes smaller and the hybrid vehicle frequently encounters a situation where the electric power from the battery cannot afford the driving power. In this situation, the emission of exhaust worsened is conspicuous.

In the hybrid vehicle of the invention and the control method of the hybrid vehicle, the main object of the invention is to drive the hybrid vehicle with output of driving power while preventing emission of exhaust worsened even when allowable electric power to be output from a battery cannot afford the driving power in a state that warm-up of a catalyst for purifying exhaust from an internal combustion engine is not completed.

In order to attain the main object, the hybrid vehicle of the invention and the control method of the hybrid vehicle have the configurations discussed below.

According to one aspect, the present invention is directed to a hybrid vehicle. The hybrid vehicle, having an internal combustion engine with an exhaust system that an exhaust purification device including a purifying catalyst for purifying exhaust is attached, a motor, and a battery that supplies and receives electric power to and from the motor, both of the internal combustion engine and the motor being capable of outputting power for driving the hybrid vehicle and the hybrid vehicle having a capability of being driven only with output power from the motor, the hybrid vehicle having: an output limit setting module that sets an output limit of the battery as a maximum allowable electric power to be output from the battery according to a state of the battery; a driving power setting module that sets a driving power required for driving the hybrid vehicle; a catalyst warming completion state determination module that determines whether the purifying catalyst is in a catalyst warming completion state that is a state of the purifying catalyst warmed up and capable of delivering performance; and a controller configured to, when it is determined by the catalyst warming completion state determination module that the purifying catalyst is not in the catalyst warming completion state and the set driving power is larger than a corresponding power to the set output limit of the battery, control the internal combustion engine and the motor so that the internal combustion engine outputs a first power obtained by subtracting the corresponding power to the set output limit of the battery from the set driving power and the hybrid vehicle is driven with the set driving power.

The hybrid vehicle according to this aspect of the invention, when the purifying catalyst is not in the catalyst warming completion state that is a state of the purifying catalyst warmed up and capable of delivering performance and a driving power required for driving the hybrid vehicle is larger than a corresponding power to an output limit of the battery as a maximum allowable electric power to be output from the battery, controls the internal combustion engine and the motor so that the internal combustion engine outputs a first power obtained by subtracting the corresponding power to the output limit of the battery from the driving power and the hybrid vehicle is driven with the driving power. Namely, the hybrid vehicle is driven with the internal combustion engine outputting the first power of the driving power and the battery outputting the residual corresponding power to the output limit of the battery of the driving power. Thus, emission of exhaust worsened is effectively prevented, in comparison with a vehicle driven with the internal combustion engine outputting the driving power. This arrangement enables to drive the hybrid vehicle with output of the driving power while preventing the emission of exhaust worsened even when the purifying catalyst is not in the catalyst warming completion state.

In one preferable application of the hybrid vehicle of the invention, the controller, when it is determined by the catalyst warming completion state determination module that the purifying catalyst is not in the catalyst warming completion state and the set driving power is not larger than the corresponding power to the set output limit of the battery while the internal combustion engine is controlled by a catalyst warming operation control that is control for acceleration of warming up the purifying catalyst, controls the internal combustion engine and the motor so that the hybrid vehicle is driven with the set driving power accompanied by the catalyst warming operation control of the internal combustion engine, and when it is determined by the catalyst warming completion state determination module that the purifying catalyst is not in the catalyst warming completion state and the set driving power is larger than the corresponding power to the set output limit of the battery while the internal combustion engine is controlled by the catalyst warming operation control, the controller controlling the internal combustion engine and the motor so that the internal combustion engine outputs the first power discontinuing the catalyst warming operation control of the internal combustion engine and the hybrid vehicle is driven with the set driving power. Namely, the hybrid vehicle is driven with the driving power accompanied by the catalyst warming operation control when the driving power is not larger than the corresponding power to the output limit while the internal combustion engine is controlled by the catalyst warming operation control, and the internal combustion engine outputs the first power discontinuing the catalyst warming operation control and the hybrid vehicle is driven with the driving power when the driving power is larger than the corresponding power to the output limit while the internal combustion engine is controlled by the catalyst warming operation control. This arrangement enables to drive the hybrid vehicle with output of the driving power while preventing the emission of exhaust worsened when the purifying catalyst is not in the catalyst warming completion state. In this case, the controller, when a temperature of the battery at system startup is less than a preset temperature that is a temperature less than or equal to zero degree centigrade, may start up the internal combustion engine immediately after the system startup and performs the catalyst warming operation control. This arrangement enables to bring the purifying catalyst early into the catalyst warming completion state and prevents worsening the emission of exhaust.

In another preferable application of the hybrid vehicle of the invention, the controller, for driving the hybrid vehicle accompanying operation of the internal combustion engine when it is determined by the catalyst warming completion state determination module that the purifying catalyst is in the catalyst warming completion state, may control the internal combustion engine and the motor so that the internal combustion engine outputs a second power obtained by adding the set driving power and a corresponding power to electric power required to charge or discharge the battery and the hybrid vehicle is driven with the set driving power.

In still another preferable application of the hybrid vehicle of the invention, the catalyst warming completion state determination module may determine that the purifying catalyst is in the catalyst warming completion state when an integrated value from the system startup of an intake air amount taken into the internal combustion engine reaches a predetermined threshold value. As a matter of course, the catalyst warming completion state determination module may determine that the purifying catalyst is in the catalyst warming completion state when a temperature of the purifying catalyst reaches to or over a temperature that makes the purifying catalyst delivers its enough performance.

In one preferable embodiment of the hybrid vehicle of the invention, the hybrid vehicle further having: a generator that inputs and outputs power and transmits electric power to and from the battery; and a planetary gear mechanism with three elements each connected to three shafts, an output shaft of the internal combustion engine, a rotating shaft of the generator, and a driveshaft linked to an axle of the hybrid vehicle, the motor may be so attached in the hybrid vehicle as to output power to any one of axles of the hybrid vehicle, and the controller may drive and control the generator while operation of the internal combustion engine.

According to another aspect, the present invention is directed to a control method of a hybrid vehicle. The hybrid vehicle has an internal combustion engine with an exhaust system that an exhaust purification device including a purifying catalyst for purifying exhaust is attached, a motor, and a battery that supplies and receives electric power to and from the motor, both of the internal combustion engine and the motor being capable of outputting power for driving the hybrid vehicle and the hybrid vehicle having a capability of being driven only with output power from the motor. The control method, when the purifying catalyst is not in the catalyst warming completion state that is a state of the purifying catalyst warmed up and capable of delivering performance and a driving power required for driving the hybrid vehicle is larger than a corresponding power to an output limit of the battery as a maximum allowable electric power to be output from the battery, controls the internal combustion engine and the motor so that the internal combustion engine outputs a first power obtained by subtracting the corresponding power to the output limit of the battery from the driving power and the hybrid vehicle is driven with the driving power.

The control method of the hybrid vehicle according to this aspect of the invention, when the purifying catalyst is not in the catalyst warming completion state that is a state of the purifying catalyst warmed up and capable of delivering performance and a driving power required for driving the hybrid vehicle is larger than a corresponding power to an output limit of the battery as a maximum allowable electric power to be output from the battery, controls the internal combustion engine and the motor so that the internal combustion engine outputs a first power obtained by subtracting the corresponding power to the output limit of the battery from the driving power and the hybrid vehicle is driven with the driving power. Namely, the hybrid vehicle is driven with the internal combustion engine outputting the first power of the driving power and the battery outputting the residual corresponding power to the output limit of the battery of the driving power. Thus, emission of exhaust worsened is effectively prevented, in comparison with a vehicle driven with the internal combustion engine outputting the driving power. This arrangement enables to drive the hybrid vehicle with output of the driving power while preventing the emission of exhaust worsened even when the purifying catalyst is not in the catalyst warming completion state.

In one preferable application of the control method of the hybrid vehicle of the invention, the control method, when the purifying catalyst is not in the catalyst warming completion state and the driving power is not larger than the corresponding power to the output limit of the battery while the internal combustion engine is controlled by a catalyst warming operation control that is control for acceleration of warming up the purifying catalyst, may control the internal combustion engine and the motor so that the hybrid vehicle is driven with the driving power accompanied by the catalyst warming operation control of the internal combustion engine, and when the purifying catalyst is not in the catalyst warming completion state and the driving power is larger than the corresponding power to the output limit of the battery while the internal combustion engine is controlled by the catalyst warming operation control, the method controlling the internal combustion engine and the motor so that the internal combustion engine outputs the first power discontinuing the catalyst warming operation control of the internal combustion engine and the hybrid vehicle is driven with the driving power. Namely, the hybrid vehicle is driven with the driving power accompanied by the catalyst warming operation control when the driving power is not larger than the corresponding power to the output limit while the internal combustion engine is controlled by the catalyst warming operation control, and the internal combustion engine outputs the first power discontinuing the catalyst warming operation control and the hybrid vehicle is driven with the driving power when the driving power is larger than the corresponding power to the output limit while the internal combustion engine is controlled by the catalyst warming operation control. This arrangement enables to drive the hybrid vehicle with output of the driving power while preventing the emission of exhaust worsened when the purifying catalyst is not in the catalyst warming completion state.

In one preferable application of the control method of the hybrid vehicle of the invention, the control method, for driving the hybrid vehicle accompanying operation of the internal combustion engine when the purifying catalyst is in the catalyst warming completion state, may control the internal combustion engine and the motor so that the internal combustion engine outputs a second power obtained by adding the driving power and a corresponding power to electric power required to charge or discharge the battery and the hybrid vehicle is driven with the driving power.

### BRIEF DESCRIPTION OF THE DRAWINGS

FIG. 1 schematically illustrates the configuration of a hybrid vehicle 20 in one embodiment of the invention;

FIG. 2 is a schematic view showing the structure of an engine 22;

FIG. 3 shows variations of an input limit Win and an output limit Wout against battery temperature Tb of a battery 50;

FIG. 4 shows variations of an input limit correction factor and an output limit correction factor against state of charge SOC of the battery 50;

FIG. 5 is a flowchart showing a drive control routine executed by a hybrid electronic control unit 70 in the embodiment;

FIG. 6 shows one example of the torque demand setting map;

FIG. 7 is an alignment chart showing torque-rotation speed dynamics of the respective rotational elements included in the power distribution integration mechanism 30 during the drive of the hybrid vehicle 20 with operation of the engine 22 in an appropriate state for acceleration of catalyst warm-up;

FIG. 8 shows an operation curve of the engine 22 used to set the target rotation speed Ne* and the target torque Te*;

FIG. 9 is an alignment chart showing torque-rotation speed dynamics of the respective rotational elements included in the power distribution integration mechanism 30 during the drive of the hybrid vehicle 20 with output of the driving power Pdrv from the engine 22 or with output of a power obtained by subtracting the battery output allowable power (k·Wout) from the driving power Pdrv;

FIG. 10 schematically illustrates the configuration of another hybrid vehicle 120 in one modified example;

FIG. 11 schematically illustrates the configuration of still another hybrid vehicle 220 in another modified example;

FIG. 12 schematically illustrates the configuration of another hybrid vehicle 320 in still another modified example; and

FIG. 13 schematically illustrates the configuration of another hybrid vehicle 420 in another modified example.

### BEST MODES OF CARRYING OUT THE INVENTION

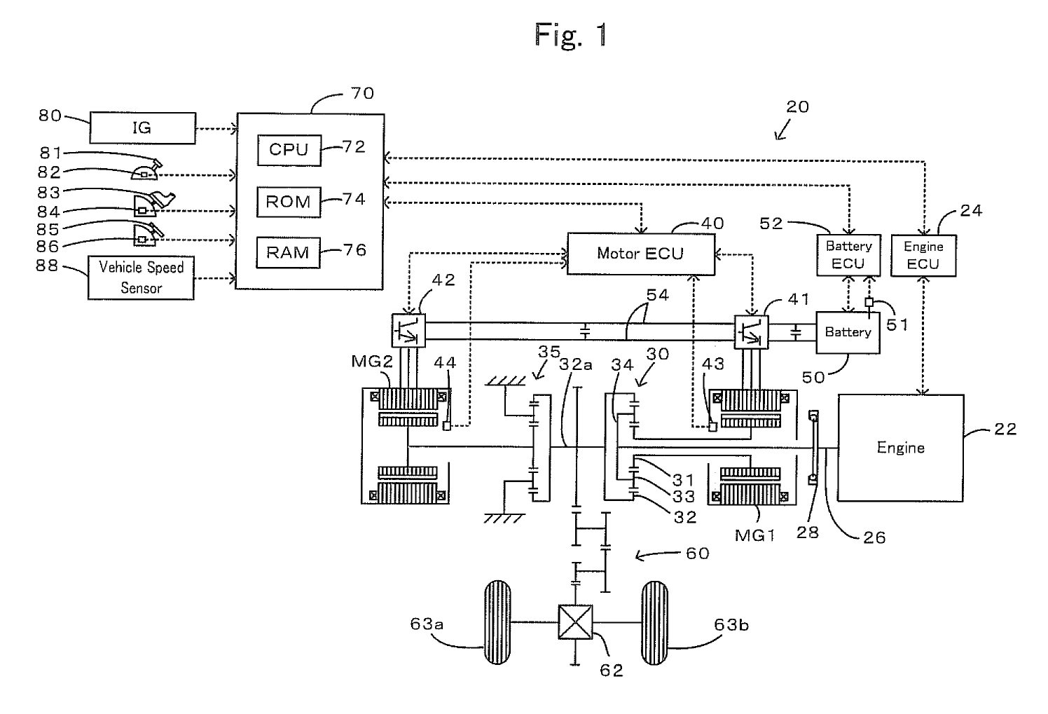

One mode of carrying out the invention is discussed below as a preferred embodiment. FIG. 1 schematically illustrates the configuration of a hybrid vehicle 20 in one embodiment according to the invention. As illustrated, the hybrid vehicle 20 of the embodiment includes the engine 22, a three shaft-type power distribution integration mechanism 30 connected via a damper 28 to a crankshaft 26 or an output shaft of the engine 22, a motor MG1 connected to the power distribution integration mechanism 30 and designed to have power generation capability, a reduction gear 35 attached to a ring gear shaft 32a or a driveshaft linked with the power distribution integration mechanism 30, a motor MG2 connected to the reduction gear 35, and a hybrid electronic control unit 70 configured to control the operations of the whole hybrid vehicle 20.

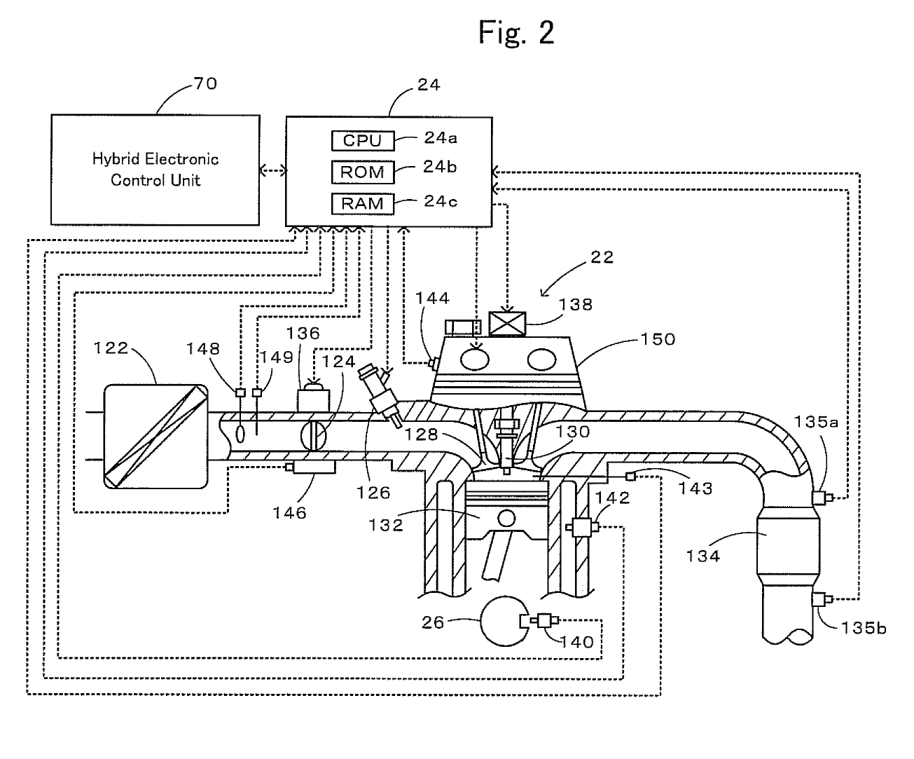

The engine 22 is an internal combustion engine that consumes a hydrocarbon fuel, such as gasoline or light oil, to output power. As shown in FIG. 2, the air cleaned by an air cleaner 122 and taken into an air intake conduit via a throttle valve 124 is mixed with the atomized fuel injected from a fuel injection valve 126 to the air-fuel mixture. The air-fuel mixture is introduced into a combustion chamber by means of an intake valve 128. The introduced air-fuel mixture is ignited with spark made by a spark plug 130 to be explosively combusted. The reciprocating motions of a piston 132 pressed down by the combustion energy are converted into rotational motions of the crankshaft 26. The exhaust from the engine 22 goes through a catalytic converter (three-way catalyst) 134 to convert toxic components included in the exhaust, that is, carbon monoxide (CO), hydrocarbons (HC), and nitrogen oxides (NOx), into harmless components, and is discharged to the outside air.

The engine 22 is under control of an engine electronic control unit (hereafter referred to as engine ECU) 24. The engine ECU 24 is constructed as a microprocessor including a CPU 24a, a ROM 24b configured to store processing programs, a RAM 24c configured to temporarily store data, input and output ports (not shown), and a communication port (not shown). The engine ECU 24 receives, via its input port, signals from various sensors designed to measure and detect the operating conditions of the engine 22. The signals input into the engine ECU 24 include a crank position from a crank position sensor 140 detected as the rotational position of the crankshaft 26, a cooling water temperature from a water temperature sensor 142 measured as the temperature of cooling water in the engine 22, an in-cylinder pressure Pin from a pressure sensor 143 located inside the combustion chamber, cam positions from a cam position sensor 144 detected as the rotational positions of camshafts driven to open and close the intake valve 128 and an exhaust valve for gas intake and exhaust into and from the combustion chamber, a throttle position from a throttle valve position sensor 146 detected as the position of the throttle valve 124, an air flow meter signal from an air flow meter 148 located in an air intake conduit, an intake air temperature from a temperature sensor 149 located in the air intake conduit, an air fuel ratio AF from an air-fuel ratio sensor 135a, and an oxygen signal from an oxygen sensor 135b. The engine ECU 24 outputs, via its output port, diverse control signals and driving signals to drive and control the engine 22. The signals output from the engine ECU 24 include driving signals to the fuel injection valve 126, driving signals to a throttle valve motor 136 driven to regulate the position of the throttle valve 124, control signals to an ignition coil 138 integrated with an igniter, and control signals to a variable valve timing mechanism 150 to vary the open and close timings of the intake valve 128. The engine ECU 24 establishes communication with the hybrid electronic control unit 70 to drive and control the engine 22 in response to control signals received from the hybrid electronic control unit 70 and to output data regarding the operating conditions of the engine 22 to the hybrid electronic control unit 70 according to the requirements. The engine ECU 24 also performs several arithmetic operations to compute a rotation speed of the crankshaft 26 or a rotation speed Ne of the engine 22 from the crank position input from the crank position sensor 140, an intake air integrated amount Ga obtained by integrating the intake air amount Qa from the air flow meter 148, and a volumetric efficiency (ratio of a volumetric capacity per cycle of air actually taken into the engine 22 to a piston displacement per cycle of the engine 22) KL based on the intake air amount Qa from the air flow meter 148 and the rotation speed Ne of the engine 22.

The power distribution and integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution and integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution and integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 63a and 63b via the gear mechanism 60, and the differential gear 62 from ring gear shaft 32a.

Both the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The battery 50 is charged with a surplus of the electric power generated by the motor MG1 or MG2 and is discharged to supplement an insufficiency of the electric power. When the power balance is attained between the motors MG1 and MG2, the battery 50 is neither charged nor discharged. Operations of both the motors MG1 and MG2 are controlled by a motor electronic control unit (hereafter referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by current sensors (not shown). The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements. The motor ECU 40 also performs arithmetic operations to compute rotation speeds Nm1 and Nm2 of the motors MG1 and MG2 from the output signals of the rotational position detection sensors 43 and 44.

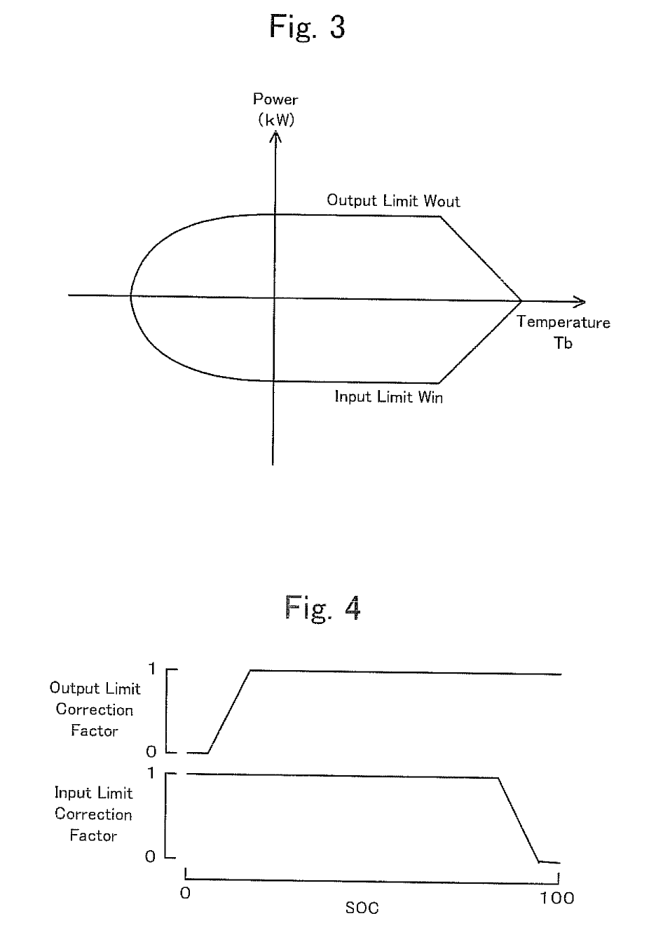

The battery 50 is under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature Tb measured by a temperature sensor 51 attached to the battery 50. The battery ECU 52 outputs data relating to the state of the battery 50 to the hybrid electronic control unit 70 via communication according to the requirements. The battery ECU 52 also performs various arithmetic operations for management and control of the battery 50. A remaining charge or state of charge (SOC) of the battery 50 is calculated from an integrated value of the charge-discharge current measured by the current sensor. An input limit Win as an allowable charging electric power to be charged in the battery 50 and an output limit Wout as an allowable discharging electric power to be discharged from the battery 50 are set corresponding to the calculated state of charge (SOC) and the battery temperature Tb. A concrete procedure of setting the input and output limits Win and Wout of the battery 50 sets base values of the input limit Win and the output limit Wout corresponding to the battery temperature Tb, specifies an input limit correction factor and an output limit correction factor corresponding to the state of charge (SOC) of the battery 50, and multiplies the base values of the input limit Win and the output limit Wout by the specified input limit correction factor and output limit correction factor to determine the input limit Win and the output limit Wout of the battery 50. FIG. 3 shows variations of the input limit Win and the output limit Wout against the battery temperature Tb of the battery 50. FIG. 4 shows variations of the input limit correction factor and the output limit correction factor against the state of charge (SOC) of the battery 50.

The hybrid electronic control unit 70 is constructed as a microprocessor including a CPU 72, a ROM 74 that stores processing programs, a RAM 76 that temporarily stores data, and a non-illustrated input-output port, and a non-illustrated communication port. The hybrid electronic control unit 70 receives various inputs via the input port: an ignition signal from an ignition switch 80, a gearshift position SP from a gearshift position sensor 82 that detects the current position of a gearshift lever 81, an accelerator opening Acc from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid electronic control unit 70 communicates with the engine ECU 24, the motor ECU 40, and the battery ECU 52 via the communication port to transmit diverse control signals and data to and from the engine ECU 24, the motor ECU 40, and the battery ECU 52, as mentioned previously.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a. Both of the torque conversion drive mode and the charge-discharge drive mode are modes for controlling the engine 22 and the motors MG1 and MG2 to output the required level of power to the ring gear shaft 32a with operation of the engine 22 and the control in the both modes practically has no difference. A combination of the both modes is thus referred to as an engine drive mode hereafter.

In the hybrid vehicle 20 of the embodiment, when the ignition switch 80 is switched to on while the battery 50 is at a lower temperature than a preset temperature (for example, −6° C. or −10° C.) that is less than or equal to 0° C., system startup is performed and the engine 22 is started up with operation of the motor MG1 immediately after the system startup. The engine 22 and the motor MG1 are then controlled so that the engine 22 is operated in an appropriate operation state to accelerate warm-up of the catalyst of the catalytic converter 134, for example, the engine 22 is operated at an drive point where the rotation speed Ne of the engine 22 is a rotation speed Nset slightly higher than an idle rotation speed and the output torque of the engine 22 is a minuscule torque Tset with delayed timing of ignition from normal timing. The hybrid vehicle 20 is driven with switching between the above described motor drive mode and engine drive mode when the catalyst warm-up is completed. The catalyst warm-up is decided to be completed and a catalyst warm-up completion flag Fc is set to value ‘1’ that is set to value ‘0’ as an initial value when the intake air integrated amount Ga reaches a preset value that is predetermined as an integrated value required for completion of the catalyst warm-up during operation of the engine 22. In the hybrid vehicle 20 of the embodiment, when the ignition switch 80 is switched to on while the battery 50 is at a temperature higher than or equal to the preset temperature, the hybrid vehicle 20 is driven in the motor drive mode without starting up the engine 22 and the engine 22 is started up upon satisfaction of a startup condition of the engine 22. After the startup of the engine 22, the catalyst warm-up is performed and the hybrid vehicle 20 is then driven in the engine drive mode.

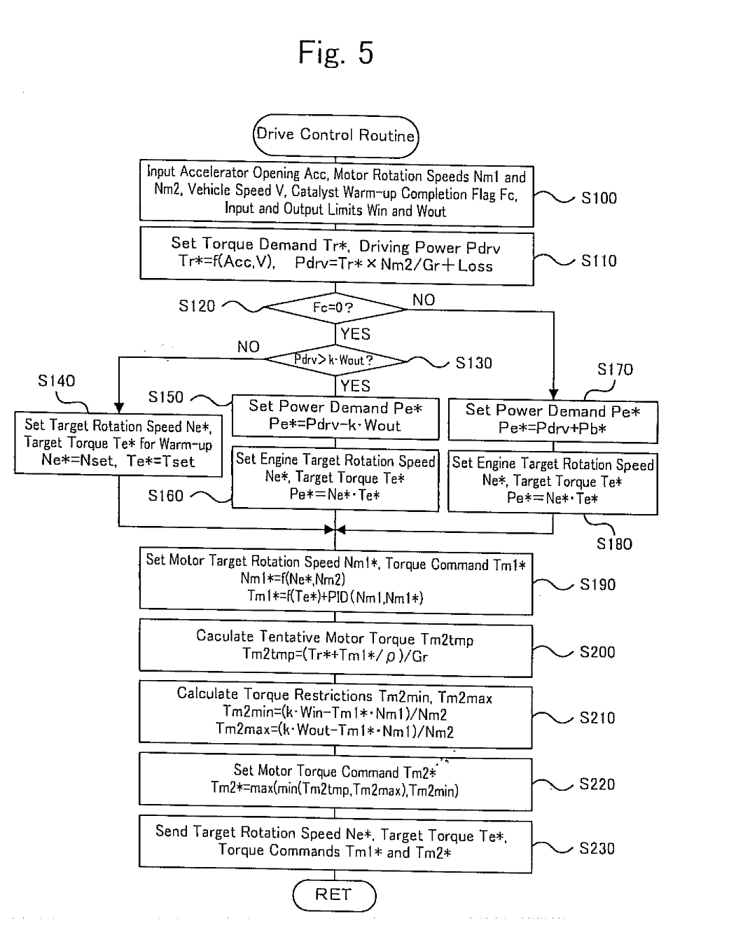

The description regards the operations of the hybrid vehicle 20 of the embodiment having the configuration discussed above, especially a series of operation control while performing the catalyst warm-up. FIG. 5 is a flowchart showing a drive control routine executed by the hybrid electronic control unit 70. This routine is performed repeatedly at preset time intervals (for example, at every several msec).

In the drive control routine, the CPU 72 of the hybrid electronic control unit 70 inputs various data required for drive control, for example, the accelerator opening Acc from the accelerator pedal position sensor 84, the vehicle speed V from the vehicle speed sensor 88, the rotation speeds Nm1 and Nm2 of the motors MG1 and MG2, the catalyst warm-up completion flag Fc, and the input limit Win and the output limit Wout of the battery 50 (step S100). The rotation speeds Nm1 and Nm2 of the motors MG1 and MG2 are computed from the rotational positions of the rotors in the motors MG1 and MG2 detected by the rotational position detection sensors 43 and 44 and are input from the motor ECU 40 by communication. The catalyst warm-up completion flag Fc is set by the engine ECU 24 and input by communication. The input limit Win and the output limit Wout of the battery 50 are set based on the battery temperature Tb and the state of charge (SOC) of the battery 50 and are input from the battery ECU 52 by communication.

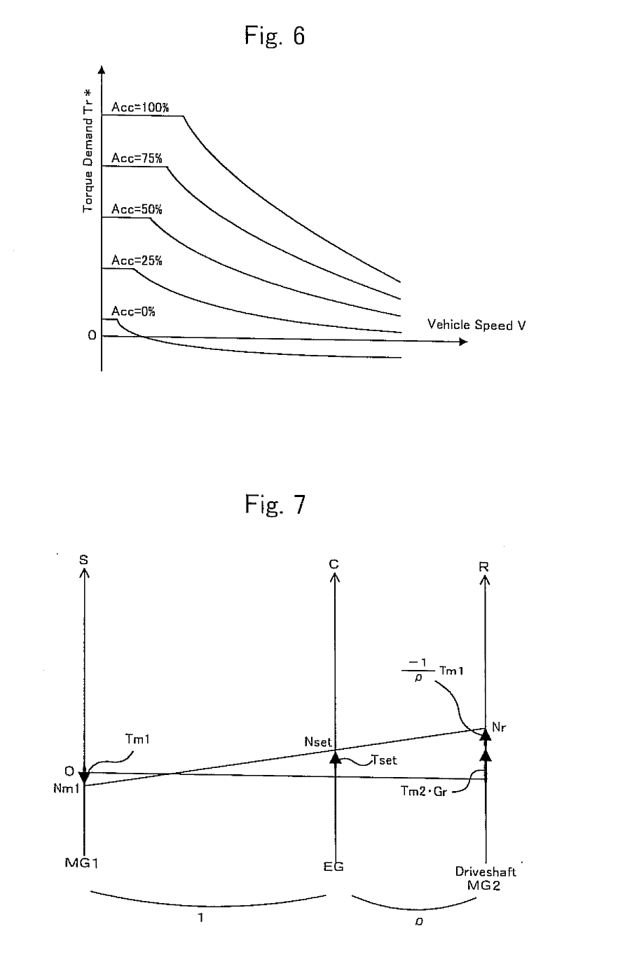

After the data input, the CPU 72 sets a torque demand Tr* to be output to the ring gear shaft 32a or the driveshaft linked with the drive wheels 63a and 63b as a torque required for the hybrid vehicle 20 based on the input accelerator opening Acc and the input vehicle speed V and sets a driving power Pdrv (step S110). A concrete procedure of setting the torque demand Tr* in this embodiment provides and stores in advance variations in torque demand Tr* against the vehicle speed V with regard to various settings of the accelerator opening Acc as a torque demand setting map in the ROM 74 and reads the torque demand Tr* corresponding to the given accelerator opening Acc and the given vehicle speed V from this torque demand setting map. One example of the torque demand setting map is shown in FIG. 6. The driving power Pdrv is calculated as the sum of the product of the set torque demand Tr* and a rotation speed Nr of the ring gear shaft 32a and a potential loss. The rotation speed Nr of the ring gear shaft 32a is obtained by multiplying the vehicle speed V by a preset conversion factor k or by dividing the rotation speed Nm2 of the motor MG2 by a gear ratio Gr of the reduction gear 35.

The CPU 72 then determines whether the catalyst warm-up completion flag Fc is value ‘0’ or not (step S120). The catalyst warm-up completion flag Fc is set as value ‘0’ when the catalyst warm-up is not completed and is set as 1 when the catalyst warm-up is completed. Upon determination that the catalyst warm-up completion flag Fc is value ‘0’, the CPU 72 compares the driving power Pdrv and a battery output allowable power (k·Wout) that is a converted power by multiplying the output limit Wout of the battery 50 by a preset conversion factor k (step S130).

When the driving power Pdrv is smaller than the battery output allowable power, the CPU 72 sets the rotation speed Nset and the torque Tset, which represent a drive point of the engine 22 appropriate to accelerate warm-up of the catalyst of the catalytic converter 134, to a target rotation speed Ne* and a target torque Te* (step S140). The CPU 72 then calculates a target rotation speed Nm1* of the motor MG1 from the target rotation speed Ne* of the engine 22, the rotation speed Nr (Nm2/Gr) of the ring gear shaft 32a, and a gear ratio ρ of the power distribution integration mechanism 30 according to Equation (1) given below, while calculating a torque command Tm1* of the motor MG1 from the calculated target rotation speed Nm1* and the current rotation speed Nm1 of the motor MG1 according to Equation (2) given below (step S190):

Nm1*=Ne*·(1+ρ)/ρ−Nm2/(Gr·ρ) (1)

Tm1*=ρ·Te*/(1+ρ)+k1(Nm1*−Nm1)+k2∫(Nm1*−Nm1)dt (2)

Equation (1) is a dynamic relational expression of respective rotational elements included in the power distribution integration mechanism 30. FIG. 7 is an alignment chart showing torque-rotation speed dynamics of the respective rotational elements included in the power distribution integration mechanism 30 during the drive of the hybrid vehicle 20 with operation of the engine 22 in the appropriate state for acceleration of catalyst warm-up. The left axis ‘S’ represents a rotation speed of the sun gear 31 that is equivalent to the rotation speed Nm1 of the motor MG1. The middle axis ‘C’ represents a rotation speed of the carrier 34 that is equivalent to the rotation speed Ne of the engine 22. The right axis ‘R’ represents the rotation speed Nr of the ring gear 32 obtained by dividing the rotation speed Nm2 of the motor MG2 by the gear ratio Gr of the reduction gear 35. Equation (1) is readily introduced from this alignment chart. Two thick arrows on the axis ‘R’ respectively show a torque applied to the ring gear shaft 32a by output of the torque Tm1 from the motor MG1, and a torque applied to the ring gear shaft 32a via the reduction gear 35 by output of the torque Tm2 from the motor MG2. Equation (2) is a relational expression of feedback control to drive and rotate the motor MG1 at the target rotation speed Nm1*. In Equation (2) given above, ‘k1’ in the second term and ‘k2’ in the third term on the right side respectively denote a gain of the proportional and a gain of the integral term. The torque Tset at the drive point of the engine 22 appropriate to accelerate warm-up of the catalyst of the catalytic converter 134 is small value and the torque command Tm1* of the motor MG1 is thus set to small value during operation of the engine 22 at the rotation speed Nset. In the alignment charge of FIG. 7, the torque Tset is exaggerated for purposes of illustration.

After calculation of the target rotation speed Nm1* and the torque command Tm1* of the motor MG1, the CPU 72 calculates a tentative motor torque Tm2tmp to be output from the motor MG2 from the torque demand Tr*, the torque command Tm1* of the motor MG1, and the gear ratio ρ of the power distribution integration mechanism 30 according to Equation (3) given below (step S200):

Tm2tmp=(Tr*+Tm1*/ρ)/Gr (3)

The CPU 72 then calculates a lower torque restriction Tmin and an upper torque restriction Tmax as allowable minimum and maximum torques output from the motor MG2 according to Equations (4) and (5) given below (step S210):

Tmin=(Win−Tm1*·Nm1)/Nm2 (4)

Tmax=(Wout−Tm1*·Nm1)/Nm2 (5)

The lower torque restriction Tmin and the upper torque restriction Tmax are obtained by dividing respective differences between the input limit Win or the output limit Wout of the battery 50 and power consumption (power generation) of the motor MG1, which is the product of the calculated torque command Tm1* and the current rotation speed Nm1 of the motor MG1, by the current rotation speed Nm2 of the motor MG2. The CPU 72 then limits the calculated tentative motor torque Tm2tmp by the lower and the upper torque restrictions Tmin and Tmax to set a torque command Tm2* of the motor MG2 (step S220). Setting the torque command Tm2* of the motor MG2 in this manner restricts the torque demand Tr* to be output to the ring gear shaft 32a or the driveshaft in the range of the input limit Win and the output limit Wout of the battery 50. Considering that the torque Tset at the drive point of the engine 22 appropriate to accelerate warm-up of the catalyst of the catalytic converter 134 is small value and the torque command Tm1* of the motor MG1 is small value as described above, the tentative motor torque Tm2tmp is set as the torque demand Tr* divided by the gear ratio Gr of the reduction gear 35 on the assumption that the torque command Tm1* is value ‘0’. Considering also that the driving power Pdrv is smaller than the battery output allowable power (k·Wout), the torque command Tm2* of the motor MG2 is set as the tentative motor torque Tm2tmp, that is, the torque demand Tr* divided by the gear ratio Gr of the reduction gear 35. Equation (3) is readily introduced from the alignment chart of FIG. 7.

After setting the target rotation speed Ne* and the target torque Te* of the engine 22 and the torque commands Tm1* and Tm2* of the motors MG1 and MG2, the CPU 72 sends the settings of the target rotation speed Ne* and the target torque Te* of the engine 22 to the engine ECU 24 and the settings of the torque commands Tm1* and Tm2* of the motors MG1 and MG2 to the motor ECU 40 (step S230) and terminates the drive control routine. In response to reception of the settings of the target rotation speed Ne* and the target torque Te*, the engine ECU 24 performs required controls including fuel injection control and ignition control of the engine 22 to drive the engine 22 at the specific drive point defined by the combination of the target rotation speed Ne* and the target torque Te*. The ignition control of the engine 22 is performed by appropriate ignition timing for the catalyst warm-up. In response to reception of the settings of the torque commands Tm1* and Tm2*, the motor ECU 40 performs switching control of the switching elements in the inverter 41 and the switching elements in the inverter 42 to drive the motor MG1 with the torque command Tm1* and the motor MG2 with the torque command Tm2*.

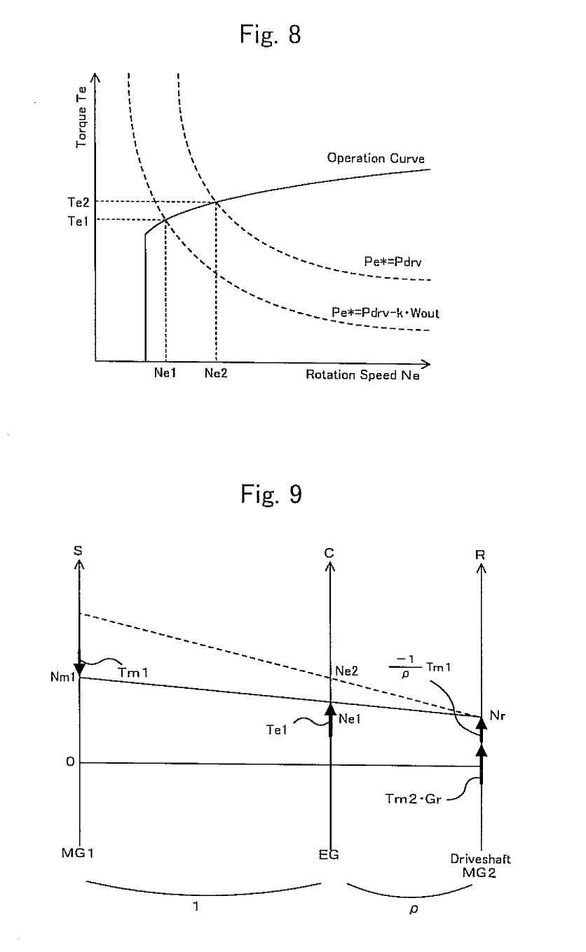

When the driving power Pdrv is larger than the battery output allowable power at step S130, the CPU 72 sets a power demand Pe* to be output from the engine 22 as a power obtained by subtracting the battery output allowable power (k·Wout) from the driving power Pdrv (step S150) and sets the target rotation speed Ne* and the target torque Te* as a rotation speed and a torque obtained from an operation curve as constraints of the rotation speed Ne and torque Te of the engine 22 to ensure efficient operation of the engine 22 and the set power demand Pe* (step S160). The CPU 72 sets the torque commands Tm1* and Tm2* of the motors MG1 and MG2 from the set target rotation speed Ne* and the target torque Te* at the processing of step S190 through 5220 above described. The CPU 72 sends the settings of the target rotation speed Ne* and the target torque Te* of the engine 22 to the engine ECU 24 and the settings of the torque commands Tm1* and Tm2* of the motors MG1 and MG2 to the motor ECU 40 (step S230) and terminates the drive control routine. FIG. 8 shows an operation curve of the engine 22 used to set the target rotation speed Ne* and the target torque Te*. One curve of a broken line represents a constant power demand Pe* set as the driving power Pdrv and another curve of a broken line represents a constant power demand Pe* set as a power (Pe*=Pdrv−k·Wout) obtained by subtracting the battery output allowable power (k·Wout) from the driving power Pdrv. As clearly shown, the target rotation speed Ne* and the target torque Te* are given as an intersection of the operation curve and a curve of constant power demand Pe* and obtained here as a rotation speed Ne1 and a torque Te1. FIG. 9 is an alignment chart showing torque-rotation speed dynamics of the respective rotational elements included in the power distribution integration mechanism 30 during the drive of the hybrid vehicle 20 with output of the driving power Pdrv from the engine 22 or with output of a power obtained by subtracting the battery output allowable power (k·Wout) from the driving power Pdrv. As shown in FIG. 8 and FIG. 9, when the engine 22 outputs the power obtained by subtracting the battery output allowable power (k·Wout) from the driving power Pdrv, the rotation speed Ne and output torque of the engine 22 are smaller than those of the engine 22 outputting the driving power Pdrv. As a result, when the engine 22 outputs the power obtained by subtracting the battery output allowable power (k·Wout) from the driving power Pdrv, emission of exhaust is more effectively prevented from becoming worse in comparison to the case where the engine 22 outputs the driving power Pdrv. In the case where the power demand Pe* to be output from the engine 22 is set as the power obtained by subtracting the battery output allowable power (k·Wout) from the driving power Pdrv and such control is performed that control to drive the hybrid vehicle 20 with the driving power Pdrv within the range of the input limit Win and the output limit Wout of the battery 50, the battery 50 is able to output the battery output allowable power (k·Wout) and the restriction by the lower and upper torque restrictions Tm2min and Tm2max set at step S210 is not executed, that is, the restriction by the input and output limits Win and Wout of the battery 50 is not executed. The tentative motor torque Tm2tmp is thus set to the torque command Tm2* of the motor MG2 and it is enabled as a result that the hybrid vehicle 20 is driven with the driving power Pdrv. In the embodiment, when the driving power Pdrv is larger than the battery output allowable power (k·Wout), the power demand Pe* to be output from the engine 22 is set as the power obtained by subtracting the battery output allowable power (k·Wout) from the driving power Pdrv and the control is performed. This arrangement enables to drive the hybrid vehicle 20 with output of the driving power while preventing more the emission of exhaust worsened, in comparison to the case where the power demand Pe* is set as the driving power Pdrv and control is performed.

Upon determination that the catalyst warm-up completion flag Fc is value ‘1’, that is, when the catalyst warm-up is completed, the CPU 72 sets the power demand Pe* as a sum of a charge-discharge power demand Pb* and the driving power Pdrv (step S170). The charge-discharge power demand Pb* is a power required to be charged into or discharged from the battery 50. The CPU 72 sets the target rotation speed Ne* and the target torque Te* as a rotation speed and a torque obtained from the operation curve and the set power demand Pe* (step S180). The CPU 72 sets the torque commands Tm1* and Tm2* of the motors MG1 and MG2 from the set target rotation speed Ne* and the target torque Te* at the processing of step S190 through S220 above described. The CPU 72 sends the settings of the target rotation speed Ne* and the target torque Te* of the engine 22 to the engine ECU 24 and the settings of the torque commands Tm1* and Tm2* of the motors MG1 and MG2 to the motor ECU 40 (step S230) and terminates the drive control routine. The power demand Pe* is set as the driving power Pdrv on the assumption that the charge-discharge power demand Pb* is value ‘0’, and the target rotation speed Ne* and the target torque Te* are set as a rotation speed Ne2 and a torque Te2 as shown in FIG. 8. The hybrid vehicle 20 is driven as shown by the broken line of the alignment chart of FIG. 9.

In the hybrid vehicle 20 of the embodiment described above, when the catalyst warm-up is not completed and the driving power Pdrv is less than or equal to the battery output allowable power (k·Wout), the target rotation speed Ne* and the target torque Te* of the engine 22 are set to the rotation speed Nset and the torque Tset that represent an appropriate drive point of the engine 22 to accelerate warm-up of the catalyst of the catalytic converter 134, and the engine 22 and the motors MG1 and MG2 are controlled so that the hybrid vehicle 20 is driven with the driving power Pdrv accompanied by operation of the engine 22 where the catalyst warm-up is performed. This arrangement effectively prevents the emission of exhaust from becoming worse. When the catalyst warm-up is not completed and the driving power Pdrv is more than the battery output allowable power (k·Wout), the power demand Pe* to be output from the engine 22 is set as a power obtained by subtracting the battery output allowable power (k·Wout) from the driving power Pdrv, and the engine 22 and the motors MG1 and MG2 are controlled so that the engine 22 outputs the power demand Pe* and the hybrid vehicle 20 is driven with the driving power Pdrv. This arrangement enables the hybrid vehicle 20 to be driven with output of the driving power Pdrv while preventing more effectively the emission of exhaust from becoming worse, in comparison to the case where the power demand Pe* is set as the driving power Pdrv and the control is performed.

In the hybrid vehicle 20 of the embodiment, when the engine 22 is in operation but the catalyst warm-up is not completed while the driving power Pdrv is larger than the battery output allowable power (k·Wout), the power demand Pe* to be output from the engine 22 is set as the power obtained by subtracting the battery output allowable power (k·Wout) from the driving power Pdrv, and the engine 22 and the motors MG1 and MG2 are controlled so that the engine 22 outputs the power demand Pe* and the hybrid vehicle 20 is driven with the driving power Pdrv. In one modified embodiment, when the catalyst warm-up is not completed upon startup of the engine 22 and the driving power Pdrv is larger than the battery output allowable power (k·Wout) after satisfaction of a condition for starting up the engine 22 during the motor drive of the hybrid vehicle 20 in the motor drive mode with operation stop of the engine 22, the power demand Pe* to be output from the engine 22 may be set as the power obtained by subtracting the battery output allowable power (k·Wout) from the driving power Pdrv and the engine 22 and the motors MG1 and MG2 may be controlled so that the engine 22 outputs the power demand Pe* and the hybrid vehicle 20 is driven with the driving power Pdrv.

In the hybrid vehicle 20 of the embodiment, when the engine 22 is in operation but the catalyst warm-up is not completed while the driving power Pdrv is larger than the battery output allowable power (k·Wout), the power demand Pe* to be output from the engine 22 is set as the power obtained by subtracting the battery output allowable power (k·Wout) from the driving power Pdrv, and the engine 22 and the motors MG1 and MG2 are controlled so that the engine 22 outputs the power demand Pe* and the hybrid vehicle 20 is driven with the driving power Pdrv. In one modified embodiment, only when the driving power Pdrv is larger than the battery output allowable power (k·Wout) between the timing when the ignition switch 80 is switched to on and the first completion of the catalyst warm-up after the switching on, the power demand Pe* to be output from the engine 22 may be set as the power obtained by subtracting the battery output allowable power (k·Wout) from the driving power Pdrv and the engine 22 and the motors MG1 and MG2 may be controlled so that the engine 22 outputs the power demand Pe* and the hybrid vehicle 20 is driven with the driving power Pdrv.

In the hybrid vehicle 20 of the embodiment, when the ignition switch 80 is switched to on while the battery 50 is at a lower temperature than the preset temperature that is less than or equal to 0° C., system startup is performed and the engine 22 is started up with operation of the motor MG1 immediately after the system startup. The engine 22 and the motor MG1 are then controlled so that the engine 22 is operated in the appropriate operation state to accelerate warm-up of the catalyst of the catalytic converter 134. This is not essential. When the ignition switch 80 is switched to on while the battery 50 is at a lower temperature than the preset temperature that is less than or equal to 0° C., system startup is performed but the engine 22 may not be started immediately after the system startup.

In the hybrid vehicle 20 of the embodiment, for the purpose of operating the engine 22 in an appropriate state for acceleration of warm-up the catalyst of the catalytic converter 134, the engine 22 and the motor MG1 are controlled so that the engine 22 is operated at the drive point where the rotation speed Ne of the engine 22 is the rotation speed Nset slightly higher than the idle rotation speed and the output torque of the engine 22 is a minuscule torque Tset with delayed timing of ignition from normal timing. In one modified embodiment, the engine 22 and the motor MG1 may be controlled so that the engine 22 is operated at the rotation speed Nset slightly higher than the idle rotation speed without outputting torque from the engine 22 with delayed timing of ignition form the normal timing.

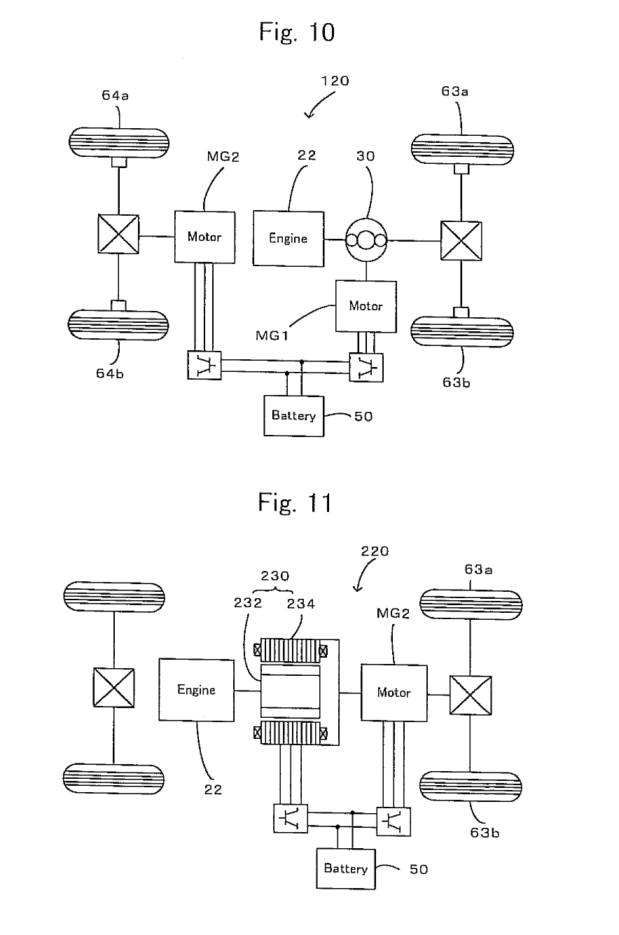

In the hybrid vehicle 20 of the embodiment, the power of the motor MG2 is converted by the reduction gear 35 and is output to the ring gear shaft 32a. The technique of the invention is also applicable to a hybrid vehicle 120 of a modified structure shown in FIG. 10. In the hybrid vehicle 120 of FIG. 10, the power of the motor MG2 is connected to another axle (an axle linked with wheels 64a and 64b) that is different from the axle connecting with the ring gear shaft 32a (the axle linked with the drive wheels 63a and 63b).

In the hybrid vehicle 20 of the embodiment, the power of the engine 22 is output via the power distribution integration mechanism 30 to the ring gear shaft 32a or the driveshaft linked with the drive wheels 63a and 63b. The technique of the invention is also applicable to a hybrid vehicle 220 of another modified structure shown in FIG. 11. The hybrid vehicle 220 of FIG. 11 is equipped with a pair-rotor motor 230. The pair-rotor motor 230 includes an inner rotor 232 connected to the crankshaft 26 of the engine 22 and an outer rotor 234 connected to a driveshaft for outputting power to the drive wheels 63a and 63b. The pair-rotor motor 230 transmits part of the output power of the engine 22 to the driveshaft, while converting the residual engine output power into electric power.

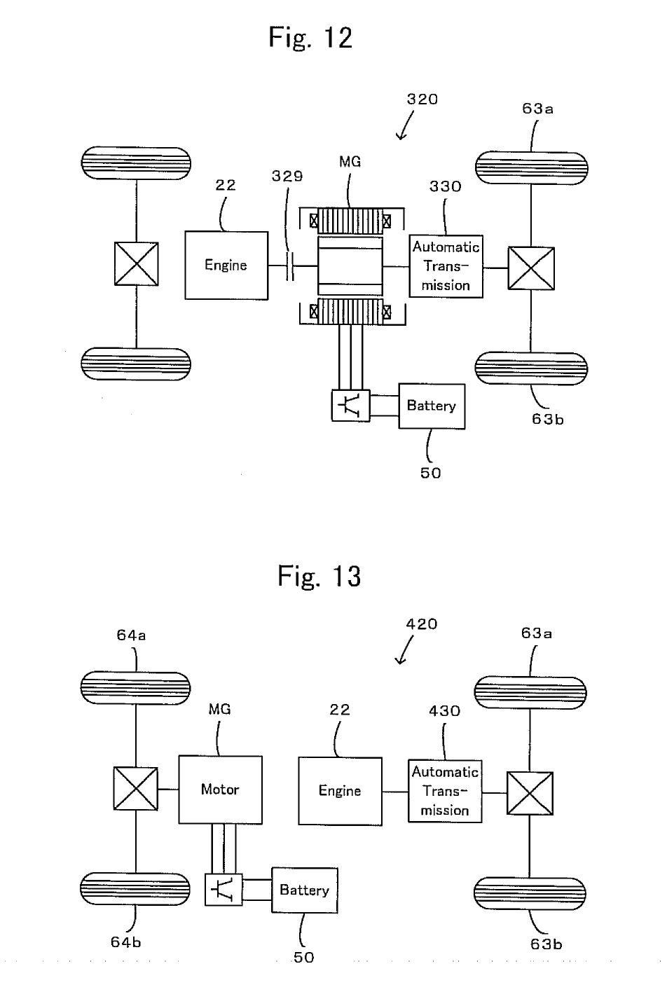

In the hybrid vehicle 20 of the embodiment, the power of the engine 22 is output via the power distribution integration mechanism 30 to the ring gear shaft 32a or the driveshaft linked with the drive wheels 63a and 63b and the power of the motor MG2 is converted by the reduction gear 35 and is output to the ring gear shaft 32a. The technique of the invention is also applicable to a hybrid vehicle 320 of still another modified structure shown in FIG. 12. A motor MG is attached to a driveshaft linked with the drive wheels 63a and 63b via an automatic transmission 330 and the engine 22 is connected to a rotating shaft of the motor MG via a clutch 329. The power of the engine 22 is output to the driveshaft via the rotating shaft of the motor MG and the automatic transmission 330 and the power of the motor MG is output to the driveshaft via the automatic transmission 330. The technique of the invention is also applicable to a hybrid vehicle 440 of another modified structure shown in FIG. 13. The power of the engine 22 is output to an axle linked with the drive wheels 63a and 63b via an automatic transmission 430 and the power of the motor MG is output to another axle (an axle linked with wheels 64a and 64b) that is different from the axle linked with the drive wheels 63a and 63b. In other words, the technique of the invention is applicable to any type of hybrid vehicles that has an engine capable of outputting power for driving and a motor capable of outputting power for driving.

The embodiment regards application of the invention to the hybrid vehicle 20. The principle of the invention may be actualized by diversity of other applications, for example, vehicles other than motor vehicles as well as a control method of such a vehicle.

The primary elements in the embodiment and its modified examples are mapped to the primary constituents in the claims of the invention as described below. The engine 22 with an exhaust system that the catalytic converter 134 having a three-way catalyst is attached in the embodiment corresponds to the ‘internal combustion engine’ in the claims of the invention. The motor MG2 in the embodiment corresponds to the ‘motor’ in the claims of the invention. The battery 50 in the embodiment corresponds to the ‘battery’ in the claims of the invention. The battery ECU 52 calculating the output limit Wout as an allowable discharging electric power to be discharged from the battery 50 according to the calculated state of charge (SOC) based on the integrated value of the charge-discharge current measured by the current sensor and the battery temperature Tb in the embodiment corresponds to the ‘output limit setting module’ in the claims of the invention. The hybrid electronic control unit 70 executing the processing of step S110 in the drive control routine of FIG. 5 to set the torque demand Tr* based on the accelerator opening Acc and the vehicle speed V and set the driving power Pdrv as the sum of the product of the set torque demand Tr* and the rotation speed Nr of the ring gear shaft 32a and the potential loss in the embodiment corresponds to the ‘driving power setting module’ in the claims of the invention. The engine ECU 24 that decides the catalyst warm-up is completed and sets the catalyst warm-up completion flag Fc, which is set to value ‘0’ as an initial value, to value ‘1’ when the intake air integrated amount Ga reaches a preset value that is predetermined as an integrated value required for completion of the catalyst warm-up during operation of the engine 22 in the embodiment corresponds to the ‘catalyst warming completion state determination module’ in the claims of the invention. The combination of the hybrid electronic control unit 70 executing the processing of the step S120 through S230 in the drive control routine of FIG. 5, the engine ECU 24 controlling the engine 22 based on the received target rotation speed Ne* and target torque Te*, and the motor ECU 40 controlling the motors MG1 and MG2 based on the received torque commands Tm1* and Tm2* in the embodiment corresponds to the ‘controller’ in the claims of the invention. The hybrid electronic control unit 70, when the catalyst warm-up is not completed and the driving power Pdrv is less than or equal to the battery output allowable power (k·Wout), sets the target rotation speed Ne* and the target torque Te* of the engine 22 to the rotation speed Nset and the torque Tset that represent an appropriate drive point of the engine 22 to accelerate warm-up of the catalyst of the catalytic converter 134, sets the torque commands Tm1* and Tm2* of the motors MG1 and MG2 so that the hybrid vehicle 20 is driven with the driving power Pdrv accompanied by operation of the engine 22 where the catalyst warm-up is performed, and sends the settings to the engine ECU 24 and the motor ECU 40. The hybrid electronic control unit 70, when the catalyst warm-up is not completed and the driving power Pdrv is more than the battery output allowable power (k·Wout), sets the power demand Pe* to be output from the engine 22 to a power obtained by subtracting the battery output allowable power (k·Wout) from the driving power Pdrv, sets the target rotation speed Ne* and the target torque Te* of the engine 22 and the torque commands Tm1* and Tm2* of the motors MG1 and MG2 so that the engine 22 outputs the power demand Pe* and the hybrid vehicle 20 is driven with the driving power Pdrv, and sends the settings to the engine ECU 24 and the motor ECU 40.

The ‘internal combustion engine’ is not restricted to the internal combustion engine designed to consume a hydrocarbon fuel, such as gasoline or light oil, and thereby output power, but may be an internal combustion engine of any other design, for example, a hydrogen engine. The ‘motor’ is not restricted to the motor MG2 constructed as a synchronous motor generator but may be any type of motor constructed to input and output power to a driveshaft, for example, an induction motor. The ‘battery’ is not restricted to the battery 50 as a secondary battery but may be any other battery designed to supply and receive electric power to and from the motor. The ‘output limit setting module’ is not restricted to the arrangement of calculating the output limit Wout according to the state of charge (SOC) of the battery 50 and the battery temperature Tb but may be any other arrangement of setting an output limit of the battery as a maximum allowable electric power to be output from the battery according to a state of the battery, for example, an arrangement of setting an output limit based on the internal resistance of the battery 50 other than the state of charge (SOC) of the battery 50 and the battery temperature Tb. The ‘driving power setting module’ is not restricted to the arrangement of setting the torque demand Tr* based on the accelerator opening Acc and the vehicle speed V and setting the driving power Pdrv as the sum of the product of the set torque demand Tr* and the rotation speed Nr of the ring gear shaft 32a and the potential loss but may be any other arrangement of setting a driving power required for driving the hybrid vehicle, for example, an arrangement of setting the driving power Pdrv using a torque demand corresponding only to the accelerator opening Acc or an arrangement of setting the driving power Pdrv using a torque demand set based on a location of the vehicle on a preset drive route. The ‘catalyst warming completion state determination module’ is not restricted to the arrangement of deciding the catalyst warm-up is completed and setting the catalyst warm-up completion flag Fc, which is set to value ‘0’ as an initial value, to value ‘1’when the intake air integrated amount Ga reaches a preset value that is predetermined as an integrated value required for completion of the catalyst warm-up during operation of the engine 22 but may be any other arrangement of determining whether the purifying catalyst is in a catalyst warming completion state that is a state of the purifying catalyst warmed up and capable of delivering performance, for example, an arrangement of determining the completion of the catalyst warm-up based on a temperature measured by a temperature sensor which is attached to the catalytic converter 134 for measuring the temperature of the three-way catalyst. The ‘controller’ is not restricted to the combination of the hybrid electronic control unit 70 with the engine ECU 24 and the motor ECU 40 but may be actualized by a single electronic control unit. The ‘controller’ is not restricted to the arrangement, when the catalyst warm-up is not completed and the driving power Pdrv is less than or equal to the battery output allowable power (k·Wout), of setting the target rotation speed Ne* and the target torque Te* of the engine 22 to the rotation speed Nset and the torque Tset that represent an appropriate drive point of the engine 22 to accelerate warm-up of the catalyst of the catalytic converter 134 and controlling the engine 22 and the motors MG1 and MG2 so that the hybrid vehicle 20 is driven with the driving power Pdrv accompanied by operation of the engine 22 where the catalyst warm-up is performed, when the catalyst warm-up is not completed and the driving power Pdrv is more than the battery output allowable power (k·Wout), of setting the power demand Pe* to be output from the engine 22 to a power obtained by subtracting the battery output allowable power (k·Wout) from the driving power Pdrv and controlling the engine 22 and the motors MG1 and MG2 so that the engine 22 outputs the power demand Pe* and the hybrid vehicle 20 is driven with the driving power Pdrv but may be any other arrangement, when it is determined by the catalyst warming completion state determination module that the purifying catalyst is not in the catalyst warming completion state and the set driving power is larger than a corresponding power to the set output limit of the battery, of controlling the internal combustion engine and the motor so that the internal combustion engine outputs a first power obtained by subtracting the corresponding power to the set output limit of the battery from the set driving power and the hybrid vehicle is driven with the set driving power.

The above mapping of the primary elements in the embodiment and its modified examples to the primary constituents in the claims of the invention is not restrictive in any sense but is only illustrative for concretely describing the modes of carrying out the invention. Namely the embodiment and its modified examples discussed above are to be considered in all aspects as illustrative and not restrictive.

There may be many other modifications, changes, and alterations without departing from the scope or spirit of the main characteristics of the present invention.

### INDUSTRIAL APPLICABILITY

The technique of the invention is preferably applied to the manufacturing industries of the hybrid vehicles.

The disclosure of Japanese Patent Application No. 2009-25076 filed on Feb. 5, 2009 including specification, drawings and claims is incorporated herein by reference in its entirety.

What is claimed is:

1. A hybrid vehicle, having an internal combustion engine with an exhaust system that an exhaust purification device including a purifying catalyst for purifying exhaust is attached, a motor, and a battery that supplies and receives electric power to and from the motor, both of the internal combustion engine and the motor being capable of outputting power for driving the hybrid vehicle and the hybrid vehicle having a capability of being driven only with output power from the motor, the hybrid vehicle comprising:
an output limit setting module that sets an output limit of the battery as a maximum allowable electric power to be output from the battery according to a state of the battery;
a driving power setting module that sets a driving power required for driving the hybrid vehicle;
a catalyst warming completion state determination module that determines whether the purifying catalyst is in a catalyst warming completion state that is a state of the purifying catalyst warmed up and capable of delivering performance; and
a controller configured to, when it is determined by the catalyst warming completion state determination module that the purifying catalyst is not in the catalyst warming completion state and the set driving power is larger than a corresponding power to the set output limit of the battery, control the internal combustion engine and the motor so that the internal combustion engine outputs a first power obtained by subtracting the corresponding power to the set output limit of the battery from the set driving power and the hybrid vehicle is driven with the set driving power.

2. The hybrid vehicle in accordance with claim 1, wherein the controller, when it is determined by the catalyst warming completion state determination module that the purifying catalyst is not in the catalyst warming completion state and the set driving power is not larger than the corresponding power to the set output limit of the battery while the internal combustion engine is controlled by a catalyst warming operation control that is control for acceleration of warming up the purifying catalyst, controls the internal combustion engine and the motor so that the hybrid vehicle is driven with the set driving power accompanied by the catalyst warming operation control of the internal combustion engine, and
when it is determined by the catalyst warming completion state determination module that the purifying catalyst is not in the catalyst warming completion state and the set driving power is larger than the corresponding power to the set output limit of the battery while the internal combustion engine is controlled by the catalyst warming operation control, the controller controlling the internal combustion engine and the motor so that the internal combustion engine outputs the first power discontinuing the catalyst warming operation control of the internal combustion engine and the hybrid vehicle is driven with the set driving power.

3. The hybrid vehicle in accordance with claim 2, wherein the controller, when a temperature of the battery at system startup is less than a preset temperature that is a temperature less than or equal to zero degree centigrade, starts up the internal combustion engine immediately after the system startup and performs the catalyst warming operation control.

4. The hybrid vehicle in accordance with claim 1, wherein the controller, for driving the hybrid vehicle accompanying operation of the internal combustion engine when it is determined by the catalyst warming completion state determination module that the purifying catalyst is in the catalyst warming completion state, controls the internal combustion engine and the motor so that the internal combustion engine outputs a second power obtained by adding the set driving power and a corresponding power to electric power required to charge or discharge the battery and the hybrid vehicle is driven with the set driving power.

5. The hybrid vehicle in accordance with claim 1, wherein the catalyst warming completion state determination module determines that the purifying catalyst is in the catalyst warming completion state when an integrated value from the system startup of an intake air amount taken into the internal combustion engine reaches a predetermined threshold value.

6. The hybrid vehicle in accordance with claim 1, the hybrid vehicle further having:
a generator that inputs and outputs power and transmits electric power to and from the battery; and
a planetary gear mechanism with three elements each connected to three shafts, an output shaft of the internal combustion engine, a rotating shaft of the generator, and a driveshaft linked to an axle of the hybrid vehicle,
wherein the motor is so attached in the hybrid vehicle as to output power to any one of axles of the hybrid vehicle, and
the controller drives and controls the generator while operation of the internal combustion engine.

7. A control method of a hybrid vehicle, the hybrid vehicle having an internal combustion engine with an exhaust system that an exhaust purification device including a purifying catalyst for purifying exhaust is attached, a motor, and a battery that supplies and receives electric power to and from the motor, both of the internal combustion engine and the motor being capable of outputting power for driving the hybrid vehicle and the hybrid vehicle having a capability of being driven only with output power from the motor,
the control method, when the purifying catalyst is not in the catalyst warming completion state that is a state of the purifying catalyst warmed up and capable of delivering performance and a driving power required for driving the hybrid vehicle is larger than a corresponding power to an output limit of the battery as a maximum allowable electric power to be output from the battery, controlling the internal combustion engine and the motor so that the internal combustion engine outputs a first power obtained by subtracting the corresponding power to the output limit of the battery from the driving power and the hybrid vehicle is driven with the driving power.

8. The control method of the hybrid vehicle in accordance with claim 7, the control method, when the purifying catalyst is not in the catalyst warming completion state and the driving power is not larger than the corresponding power to the output limit of the battery while the internal combustion engine is controlled by a catalyst warming operation control that is control for acceleration of warming up the purifying catalyst, controlling the internal combustion engine and the motor so that the hybrid vehicle is driven with the driving power accompanied by the catalyst warming operation control of the internal combustion engine, and
when the purifying catalyst is not in the catalyst warming completion state and the driving power is larger than the corresponding power to the output limit of the battery while the internal combustion engine is controlled by the catalyst warming operation control, the method controlling the internal combustion engine and the motor so that the internal combustion engine outputs the first power discontinuing the catalyst warming operation control of the internal combustion engine and the hybrid vehicle is driven with the driving power.

9. The control method of the hybrid vehicle in accordance with claim 7, the control method, for driving the hybrid vehicle accompanying operation of the internal combustion engine when the purifying catalyst is in the catalyst warming completion state, controlling the internal combustion engine and the motor so that the internal combustion engine outputs a second power obtained by adding the driving power and a corresponding power to electric power required to charge or discharge the battery and the hybrid vehicle is driven with the driving power.
